(19) United States
(12) Patent Application Publication
(10) Pub. No.: US 2011/0183941 A1
(43) Pub. Date: Jul. 28, 2011

(54) Herbicide consisting of a glyphosate formulation containing a surfactant consisting in a branched alkyl alcohol polyethoxylated or polypropoxylated and a mixture of alkylamines

(76) Inventor: Pedro Brito Correia, (US)

(21) Appl. No.: 12/691,755

(22) Filed: Jan. 22, 2010

(51) Int. Cl. A01N 57/20; A01P 13/00

(52) U.S. Cl. 514/114

(57) ABSTRACT

Linear alkyl amine polyethoxylated containing in the alkyl chain 16 to 20 carbon atoms are worldwide used as surfactants for herbicides based on glyphosate.

Concerns on the negative effects on environment and health of these surfactants forced the search to new compounds.

Branched alkyl alcohol polyethoxylated or polypropoxylated with alkyl chains with 10-12 carbon atoms present a much lower surface tension and lower toxicity than linear alkylamines polyethoxylated or polypropoxylated.

The reason for the lower surface tension in water solutions is the steric hindrance of micelles formation caused by the branch. Micelles consisting of surfactant molecules reduce the amount of surfactant available to decrease the surface tension. The reason for the lower toxicity measured in algal growth inhibition and daphnia tests as well as eye irritation tests in rabbits is the absence of the amine function and the reduction in the chain length.

However, branched alkyl alcohols polyethoxylated or polypropoxylated have a limited solubility in the glyphosate formulations based on isopropylamine or alkaline metal hydroxides, earlier used together with the linear alkylamine polyethoxylated.

We found that the substitution of part of isopropylamine by ethyl hexyl amine or other C4 to C8 mono or diamines creates a compromise between the hydrophilic characteristics of the formulation to solve glyphosate and the lipophilic characteristics to solve the branched alkyl alcohol polyethoxylated.

### FIELD OF INVENTION

Herbicides, Glyphosate formula ions, Surfactants

### BACKGROUND OF THE INVENTION

Important concerns on health and environment exist worldwide on the consequences of the application of herbicides and other pesticides for food production. The need to strongly increase the yields of food per hectar and the quality of food are important factors influencing the use of pesticides, considering the problems of hunger.

In order to find a compromise between these two opposite factors, the European Commission approved the Regulation 1107/2009. the US Government approved FIFRA, and FAO and the World Health Organisation are preparing a Guideline on the Use of Pesticides to be adopted by all countries.

The objective is to harmonize the rules on the sales authorization of pesticides and to select for the same applications the pesticide which is more health and environment friendly.

The World Trade Organisation created a free market, and it is unacceptable that at the same time food originated in some countries is exported to other countries, where the residues of pesticides in the food do not comply with existing rules in the importing countries.

Since glyphosate was patented by the US company Monsanto, alkylamine polyethoxylated as surfactants were included in the first patents and widely used.

The length of the linear alkyl chain was subject to optimising efforts, the use of other surfactants to be mixed with alkylamine polyethoxylated was also tried, the use of other families of compounds like alkylphosphonates polyethoxylated, polysiloxanes, sarcosinates, betain polyethoxylates and many other compounds have been patented.

Glyphosate is by far the most sold pesticide worldwide, and its production volumes were even increased by the introduction in many countries of the genetic modified seeds resistant to glyphosate.

A surfactant for such high volume herbicide has to present a high performance and availability but must have a low cost.

A good surfactant allows a reduction of the quantity of active substance per hectar, and improves the speed of absorption of the water solution of the glyphosate formulation by the leaves of the weeds. This makes possible the application of glyphosate a shorter time before it rains as compared to standard formulations.

In fact, if it rains a shorter time after the application of the herbicide containing a very efficient surfactant, there will be no more herbicide on the leaves, because it was absorbed.

### DETAILED DESCRIPTION OF THE INVENTION

It is well known from surfactant chemistry that the surfactant molecules act by making a monolayer around the particle to be dispersed or emulsified in water.

A surfactant molecule consists of a lipophilic part attracted by the particle to be emulsified and a hydrophilic part which is oriented in the opposite direction.

The surfactant orients itself on the water surface with the lipophilic part of the molecules oriented to the air, and the hydrophilic part directed to the center of the water drop. The surfactant builds like a fat thin layer on the water surface.

Based on this mechanism it is possible to reduce the size of droplets by spraying a water solution of an herbicide. Besides this effect, the droplets in contact to the surface of the leaves are not spheric, which would make them to fall to ground. The droplets are spread in the surface of the leaves, because the attraction of the solution molecules to the leaves is bigger than the attraction of the molecules of the solution among themselves.

Some surfactant molecules have the tendency to come together in clusters building micelles, instead of going apart from each other and increasing the interaction with the solvent and reducing its surface tension.

The formation of micelles reduces the amount of surfactant available to reduce the surface tension.

On the other side, glyphosate is an aminoacide, therefore presenting an amphoteric character, and an isoelectric point in water solutions. The solubility of glyphosate is only 1.5% at room temperature and the pH of this solution is around 2, which is the isoelectric point

In order to increase the solubility of glyphosate it is necessary to increase the pH by adding an alkaline hydroxyde or an amine.

It was found that the addition of an amine increases the miscibility of the surfactant in the solution.

A loner chain of the alkyl group of the surfactant normally reduces its biodegradability and increases its toxicity.

Alkyl groups contained in 2-propylheptyl alcohol polyethoxylated or polypropoxylated cause a favourable behavior in the daphnia test, in the test of alga growth inhibition, eye irritation test and in biodegradability, as compared to linear C16-C18 alkyl groups from natural fat.

We propose now to use a surfactant consisting of branched alkyl groups as an alcohol polyethoxylated or polypropoxylated.

In order to make the branched alcohol polyethoxylated or polypropoxylated soluble, we must increase the lipophilic properties of the glyphosate formulation by substituting part of the isopropylamine by an alkyl amine containing instead of 3 carbon atoms, 4 to 10 carbon atoms.

Because of its industrial availability as a raw material for plasticizers (DOP), we used 2-ethylhexyl amine.

However, the lipophilic properties of the solution should not be two strong, in order to avoid the insolubility of glyphosate.

We must find a compromise in the mole fraction of isopropylamine to 2-ethylhexylamine in order to make soluble at the same time glyphosate and the new surfactant. We achieved that at about 1 mole ethylhexylkamine to 2-4 moles of isopropylamine.

The formulation obtained is far better concerning: toxicity and efficacy than any tested alkylamine polyethoxylated, with alkyl chain branched or not.

### Example

We mix following quantities in a stirred reactor with 1.5 liters:

| | | |
|---|---|---|
| Water | 460 | g |
| Isopropylamine | 100 | g |
| 2-ethylhexylamine | 65 | g |
| 2-Propylheptylalcohol polyethoxylated | 180 | g |
| After the solution was prepared, we add | 380 | g |
| Glyphosate 95% technical grade | | |
| Total | 1185 | g/liter |

After total solution we measured the surface tension by the ring method of a 1% water solution and found 18 mN/m. This is a better surface tension than the typical value of 32 mN/m.

Field trials are underway.

### BIBLIOGRAPHY

1. Portuguese Patent 005/103372
2. U.S. Pat. No. 5,258,359
3. U.S. Pat. No. 5,658,853
4. U.S. Pat. No. 5,663,117
5. U.S. Pat. No. 5,912,209
6. U.S. Pat. No. 6,734,141
7. EU Patent 1 541 023

1. An herbicide consisting of a glyphosate water solution containing besides glyphosate itself, a surfactant consisting of an alkylalcohol polyethoxylated or polypropoxylated, where the alkyl group is branched in order to reduce substantially the surface tension and improve efficacy and containing both isopropylamine and an amine with 4-10 carbon atoms

2. In the product of claim 1 where the alkyl carbon chain of the surfactant contains 10-14 carbon atoms, the chain, is not linear and may therefore include methyl, ethyl, propyl, butyl side groups, as for example 2-propylheptyl alcohol polyethoxylated or polypropoxylated.

3. In the product of claim 1 where the second amine besides isopropylamine is 2-ethylhexyl amine

4. In the product of claim 1 where the number of ethylene oxide or propylenoxyde monomers in the chain is 2 to 20 preferably 5 to 10

5. In the product of claim 1 where the pH of the solution is adjusted to 4.2-5.0 in order to improve the solubility of glyphosate well out of its isoelectric point of about pH=1.5.

6. In the product of claim 1 where the proportion of the C3 and C4-C10 amines is chosen as to achieve a lipophilic—hydrophilic compromise to make soluble at the same time glyphosate and the surfactant.

7. In the product of claim 1 where the branched alkyl alcoholpolyethoxylated or polypropoxylated is mixed in a proportion of 1 to 99% with linear or branched alkyl amines polyethoxylated or polypropoxylated, alkylphosphonic acids polyethoxylated or polypropoxylated.
